(19) United States
(12) Patent Application Publication
(10) Pub. No.: US 2025/0265351 A1
(43) Pub. Date: Aug. 21, 2025

(54) ASSESSING RISK FOR APPLICATION PROGRAMMING INTERFACE TRANSACTIONS USING SOFTWARE BILLS OF MATERIALS

(71) Applicant: Cisco Technology, Inc., San Jose, CA (US)

(72) Inventors: Ted Hulick, Pearland, TX (US); Thomas Szigeti, Vancouver (CA); David J. Zacks, Vancouver (CA)

(21) Appl. No.: 18/583,260

(22) Filed: Feb. 21, 2024

(51) Int. Cl. G06F 21/57; G06F 9/54

(52) U.S. Cl. CPC G06F 21/577; G06F 9/54; G06F 2221/033

(57) ABSTRACT

A method, computer system, and computer program product are provided for analyzing application programming interface (API) transactions for risk. A call stack is analyzed in relation to an incoming API request to identify one or more application components of the call stack that relate to the API request. A software bill of materials is obtained for each of the one or more application components. Risk metadata associated with each software bill of materials is analyzed to determine that the API request satisfies one or more risk criteria. A response to the API request is provided.

### TECHNICAL FIELD

The present disclosure relates generally to analyzing application programming interface transactions to assess risk.

### BACKGROUND

An application programming interface (API) is a set of rules and protocols that enables one software application to interact with another. APIs define the methods and data formats that applications can use to communicate with each other. APIs are used to enable the integration of different software systems, allowing the systems to work together and share data in a standardized way. In the context of transactions between different systems, APIs define the rules and methods through which one system can request and receive data from another system, or cause other actions to be performed by the other system.

### BRIEF DESCRIPTION OF THE DRAWINGS

FIG. 1 is a block diagram depicting a network environment for analyzing application programming interface (API) transactions to assess risk, according to an example embodiment.

FIG. 2 is a diagram depicting a call stack, according to an example embodiment.

FIG. 3 is a flow diagram depicting an API transaction that is analyzed with respect to risk, according to an example embodiment.

FIG. 4 is a flow chart of a method for evaluating an API transaction for risk, according to an example embodiment.

FIG. 5 is a block diagram of a device that may be configured to perform operations relating to analyzing API transactions for risk, as presented herein.

### DETAILED DESCRIPTION

### Overview

According to one embodiment, techniques are provided for analyzing API transactions to assess risk. A call stack is analyzed in relation to an incoming API request to identify one or more application components of the call stack that relate to the API request. A software bill of materials is obtained for each of the one or more application components. Risk metadata associated with each software bill of materials is analyzed to determine that the API request satisfies one or more risk criteria. A response to the API request is provided.

### Example Embodiments

Present embodiments relate to assessing risk by analyzing application programming interface (API) transactions to assess risk exposure to an enterprise. Conventional approaches to assessing API risk typically involve host/port penetration testing and payload analysis, which can lead to many false positives. Additionally, these conventional techniques are not granular enough to assess the risk of specific APIs. The conventional software tools for assessing API risk typically analyze network activity in the lower network layers (e.g., Open Systems Interconnection (OSI) layers 1-4), as encryption is typically standard on higher layers, and without a public key, there is limited visibility with regard to the data in those layers.

Another limitation of the conventional techniques for assessing API risk is that host and port number alone do not necessarily constitute an API. A host can be running multiple applications using multiple components, which can all appear on the same port. For example, when applications are behind a load balancer, a remote computer may not be ultimately communicating with the host with which the remote computer appears to be communicating.

To address this problem, the embodiments presented herein provide an improved approach to assessing the risk of API transactions by analyzing software bills of materials in the context of API transactions. A Software Bill of Materials (SBOM) is a detailed list of components, dependencies, and other software elements that are used to build a particular piece of software. An SBOM provides a comprehensive inventory of all the software components within a system, including third-party libraries, open-source software, and proprietary code. One purpose of an SBOM is to enhance transparency and traceability in the software development and supply chain. SBOMS aid organizations and governments in understanding the composition of their software, identifying potential security vulnerabilities or licensing issues, and managing software assets more effectively.

An API transaction can be mapped to a call stack, which is a data structure that manages the flow of control in a program. A call stack monitors the execution context of a program's functions or methods. Call stack sampling (also referred to as call stack scanning) can be performed to automatically identify components of a call stack that are involved in a particular API transaction. Call stack sampling is a technique to gather information about the state of the call stack at specific intervals during program execution by taking periodic snapshots of the call stack to understand which functions are currently active and how much time is spent within each function. Next, the components that are identified as active can be mapped to particular SBOMs, which can be used to assess the risk involved in an API transaction. In particular, SBOMs can include metadata descriptive of risk of each application, including any known vulnerabilities or other relevant information. Thus, an incoming API request can be assessed for risk by sampling a call stack to identify active components and retrieving the SBOMs associated with each component.

Accordingly, present embodiments improve the technical field of data security by providing a fine-grained approach to API risk assessment that combines call stack sampling with SBOMs to obtain a listing of all software components involved in an API transaction and to assess risk accordingly. An enterprise can selectively determine whether to permit or deny API transactions based on risk, greatly enhancing network security by mitigating risk exposure. Thus, present embodiments provide the practical application of improving data security by reducing or eliminating exposure to risk using a novel approach to API risk assessment.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description, and appended claims, or may be learned by the practice of embodiments as set forth hereinafter.

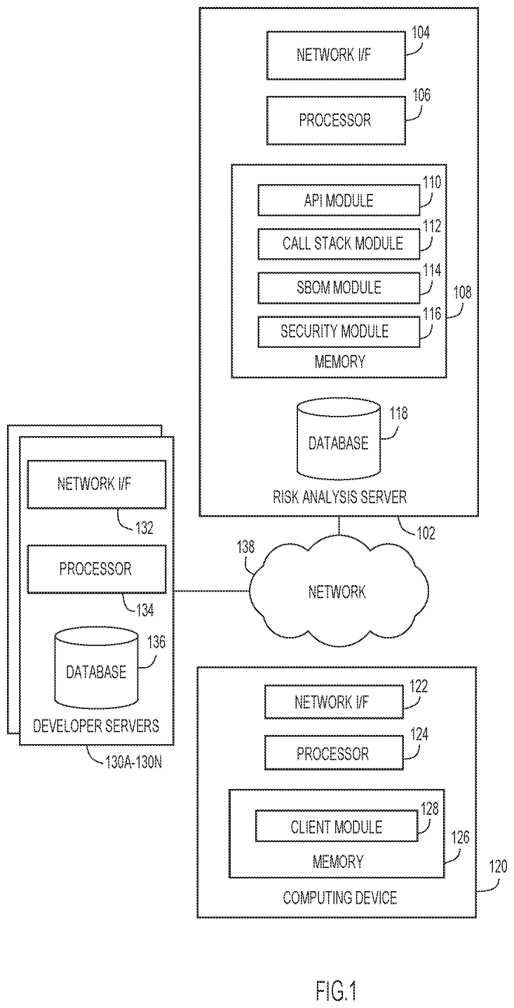

With reference now to FIG. 1, a block diagram is presented depicting a network environment 100 for analyzing application programming interface (API) transactions to assess risk, according to an example embodiment. As depicted, network environment 100 includes a risk analysis server 102, a computing device 120, and a plurality of developer servers 130A-130N that are in communication via a network 138. It is to be understood that the functional division among components have been chosen for purposes of explaining various embodiments and is not to be construed as a limiting example.

Risk analysis server 102 includes a network interface (I/F) 104, at least one processor (computer processor) 106, memory 108 (which stores instructions for an API module 110, a call stack module 112, an SBOM module 114, and a security module 116), and a database 118. In various embodiments, risk analysis server 102 may include a rack-mounted server, laptop, desktop, smartphone, tablet, or any other programmable electronic device capable of executing computer readable program instructions. Network interface 104 may be a network interface card that enables components of risk analysis server 102 to send and receive data over a network, such as network 138. Risk analysis server 102 may be configured to analyze incoming API requests using call stacks and SBOMs in order to assess the risks involved in relation to the API requests.

API module 110, call stack module 112, SBOM module 114, and security module 116 may include one or more modules or units to perform various functions of the embodiments described below. API module 110, call stack module 112, SBOM module 114, and security module 116 may be implemented by any combination of any quantity of software and/or hardware modules or units, and may reside within memory 108 of risk analysis server 102 for execution by a processor, such as processor 106.

API module 110 may be configured to receive API requests from remote computing devices (e.g., computing device 120) and respond to API requests in accordance with the embodiments presented herein. API module 110 may include one or more APIs that convert incoming requests into another form that can be processed by risk analysis server 102. Various processing tasks may be performed in order to respond to the API requests, such as execution of particular applications, database queries, and the like. When a processing task is completed, API module 110 may be provided with the results, which can be converted into another form before transmitting to the remote computing device as a response to an API request. API module 110 may be configured to selectively respond to API requests based on any risks that are identified with regard to the API requests. For a requested execution task, API module 110 may identify any software modules involved in the execution task for analysis by call stack module 112, SBOM module 114, and/or security module 116.

Call stack module 112 may analyze call stacks of software modules in order to identify particular components that are associated with API requests so that the API requests can be assessed for risk. A call stack for one or more applications can be obtained using a debugging, profiling, or performance analysis tool, which can access the call stack in memory. Call stack module 112 may be configured to identify particular components in a call stack that are active at different times (e.g., over the course of execution of an application) by sampling/scanning the call stack. When an API request is received, call stack module 112 can thus determine which components in a call stack are active, which can correspond to the components that are involved in processing the API request. The active components can be provided to SBOM module 114 in order to identify SBOMs for each component.

SBOM module 114 may maintain a library of SBOMs that correspond to any applications in use by risk analysis server 102. Each SBOM may include a listing of components included in a particular application, and can be obtained from a developer (e.g., from database 136 of any of developer servers 130A-130N). In some embodiments, each SBOM may include metadata that describes the risk of the application to which each SBOM corresponds. Risk can be described in terms of whether there are any known vulnerabilities in an application, the number of vulnerabilities, and the like. In some embodiments, the risk metadata may extend to previous versions of applications, thus capturing a history of an application. For example, the risk metadata may indicate a number of vulnerabilities for each version of an application, the time spent by a developer remediating the vulnerabilities, and other historical data that can indicate how quickly a future known vulnerability might be remediated. The risk metadata may indicate other known issues with applications, such as software defects (e.g., bugs), consumption of excessive system resources, concurrency issues (e.g., race conditions, data corruption, etc.), configuration issues, poor scalability, incompatibilities with other applications or operating systems, and the like. SBOM module 114 may indicate the SBOMs and/or the associated risk metadata for any components of a call stack that are indicated by call stack module 112 as related to an API request.

Security module 116 may analyze the risk involved in API transactions by assessing an incoming API request for risk using the risk metadata indicated by SBOM module 114. Security module 116 may analyze the risk metadata and can employ predetermined criteria for assessing an API transaction for risk and consequentially performing specific actions. Security module 116 can selectively permit or deny API transactions based on risk. In some embodiments, security module 116 may select a suitable alternative application for executing an API transaction if a particular application is associated with risk. Additionally or alternatively, security module 116 can transmit a notification to a user, such as a user of a device from which the API request originated and/or a network administrator, to inform the user that the API transaction is associated with risk. In some embodiments, predefined rules may be provided that enable a risk score to be computed for an API transaction. The risk score can be based on one or more values, such as a number of vulnerabilities, a category of the API transaction (e.g., whether the API transaction involves a request for public data or private/confidential data, etc.), or other features that are relevant to assessing risk (e.g., whether the API transaction may cause software defects, consumption of excessive system resources, concurrency issues, configuration issues, scalability issues, and/or incompatibilities with other applications or operating systems). Each factor that is considered in computing a risk score can be independently weighted so that some factors may have greater influence over the risk score. Thus, security module 116 can compute a risk score for an API transaction, which can be compared to a threshold value to evaluate an API transaction for risk.

In some embodiments, the assessment of risk by security module 116 can be published to a network-accessible forum or repository, such as an organization that defines specifications for APIs (e.g., the OpenAPI Initiative, etc.). In some embodiments, the risk score and/or other data relating the risk assessment of an API that is determined can be provided to an entity that placed the API request (e.g., computing device 120). The risk score and/or any other risk data can be inserted into a response header, such as a Hypertext Transfer Protocol (HTTP) response header, to enable a client device to also evaluate the risk of an API transaction and determine whether or not to proceed with the transaction. Similarly, a JavaScript Object Notation (JSON) Web Token can be provided to another computing entity (e.g., the requesting entity of the API transaction) that includes a list of SBOMs, or hyperlinks to SBOMs, that are involved in the API transaction and/or considered in the risk assessment.

In some embodiments, the risk criteria may include any indication that an application includes a vulnerability. Thus, if there is a vulnerability present, then actions may be taken such as preventing the API transaction from occurring, issuing a notification to a user, and the like. In other embodiments, the risk criteria may include comparison of a risk score to a threshold value. In some embodiments, the risk criteria may stipulate acceptable or unacceptable vulnerabilities or other issues that are associated with performing the API transaction. Thus, an API transaction may be approved despite being associated with some level of risk. In some embodiments, the risk criteria may include a trusted API source list, a trusted list of external calls made when responding to an API request, and/or a list of permitted operations with regard to responding to an API request. Similarly, the risk criteria can be defined as a list of unpermitted actions, such as untrusted API sources, untrusted external calls, and/or unpermitted operations.

Database 118 may include any non-volatile storage media known in the art. For example, database 118 can be implemented with a tape library, optical library, one or more independent hard disk drives, or multiple hard disk drives in a redundant array of independent disks (RAID). Similarly, data in database 118 may conform to any suitable storage architecture known in the art, such as a file, a relational database, an object-oriented database, and/or one or more tables. Database 118 may store data including SBOMs and/or associated risk metadata, risk criteria, risk scores for applications, associations between call stack components and SBOMs, and the like.

Computing device 120 may include a network interface (I/F) 122, at least one processor (computer processor) 124, and memory 126 (which stores instructions for a client module 128). In various embodiments, computing device 120 include a rack-mounted server, laptop, desktop, smartphone, tablet, or any other programmable electronic device capable of executing computer readable program instructions. Network interface 122 enables components of computing device 120 to send and receive data over a network, such as network 138. Computing device 120 may participate in API transactions with risk analysis server 102. In particular, computing device 120 may be a requesting device that provides one or more API requests to risk analysis server 102 in order to attempt to perform API transactions, which can be evaluated for risk in accordance with the embodiments presented herein. Client module 128 may include one or more modules or units to perform various functions of the embodiments described herein. Thus, client module 128 may be configured to participant in API transactions by providing API requests and/or receiving responses to API requests.

Developer servers 130A-130N may each include a network interface (I/F) 132, at least one processor (computer processor) 134, and a database 136. In various embodiments, developer servers 130A-130N may each include a rack-mounted server, laptop, desktop, smartphone, tablet, or any other programmable electronic device capable of executing computer readable program instructions. Network interface 132 enables components of each developer server 130A-130N to send and receive data over a network, such as network 138. Developer servers 130A-130N may each represent a server maintained by a software developer, which can include executable applications for use by other computing entities (e.g., risk analysis server 102 and/or computing device 120), and/or SBOMs for software applications.

Database 136 may include any non-volatile storage media known in the art. For example, database 136 can be implemented with a tape library, optical library, one or more independent hard disk drives, or multiple hard disk drives in a redundant array of independent disks (RAID). Similarly, data in database 136 may conform to any suitable storage architecture known in the art, such as a file, a relational database, an object-oriented database, and/or one or more tables. Database 136 may store data including SBOMs for various software applications. Database 136 may be accessible by risk analysis server 102 in order to enable access to SBOMs so that risk analysis server 102 can evaluate API transactions with respect to risk. The SBOMs stored in database 136 may include different SBOMs for each version of an application.

Network 138 may include a local area network (LAN), a wide area network (WAN) such as the Internet, or a combination of the two, and includes wired, wireless, or fiber optic connections. In general, network 138 can be any combination of connections and protocols known in the art that will support communications between risk analysis server 102, computing device 120, and/or developer servers 130A-130N via their respective network interfaces in accordance with the described embodiments.

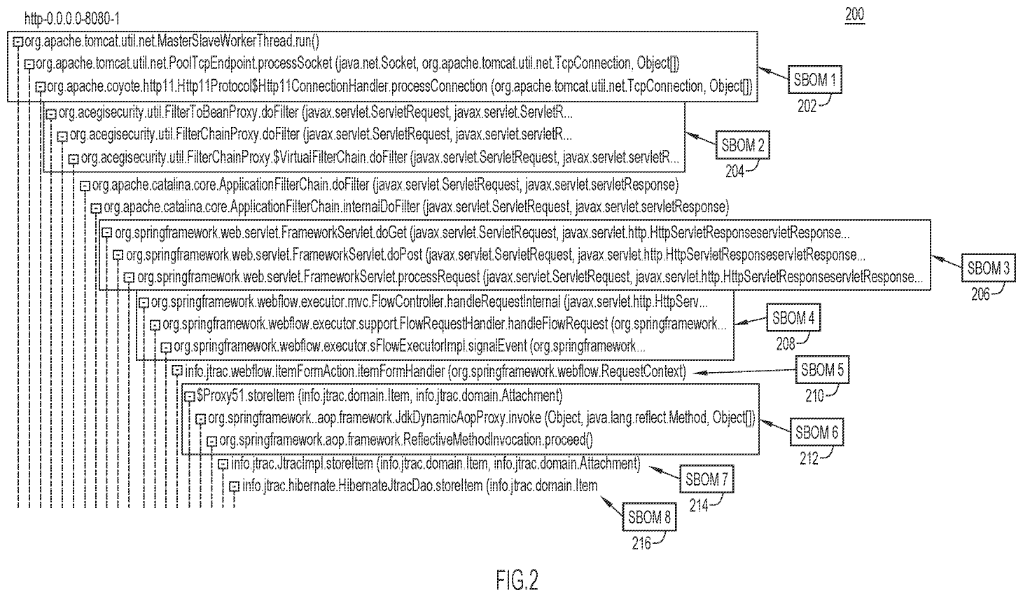

With reference now to FIG. 2, a diagram is provided depicting a call stack 200, according to an example embodiment. As depicted, call stack 200 is a nested list of components 202-216 involved in an application. The components 202-216 can include one or more APIs, subcomponents of APIs, and/or any other components of an application (e.g., a web application executing on a server, such as risk analysis server 102, which is depicted and described with reference to FIG. 1).

Each line of call stack 200 may correspond to a particular set of code that calls a next set of code corresponding to the line that is nested immediately below. The bounding boxes for each component 202-216 indicate the portions of code that collectively constitute each component in call stack 200, each of which can be associated with an SBOM. In the depicted example, component 202 corresponds to “SBOM 1”, component 204 corresponds to “SBOM 2”, component 206 corresponds to “SBOM 3”, component 208 corresponds to “SBOM 4”, component 210 corresponds to “SBOM 5”, component 212 corresponds to “SBOM 6”, component 214 corresponds to “SBOM 7”, and component 216 corresponds to “SBOM 8”.

When an incoming API request is received, call stack 200 can be scanned in order to identify active components, and the SBOMs for any active components can be obtained in order to assess the API request for risk. In some embodiments, call stack 200 is presented to a user via a user interface, and the active component(s) can be indicated using visual identifiers in order to indicate to the user that those components are active. Thus, a user can visually determine which components are involved in an API transaction, and the user can see the SBOMs that relate to those components. In some embodiments, each SBOM can be labeled with respect to risk using a graphical indicator. For example, a risk score can be displayed on or near each component 202-216 (e.g., on or near a bounding box or label for each component), or a color schema can indicate trusted components and/or untrusted components (e.g., using green and red colors).

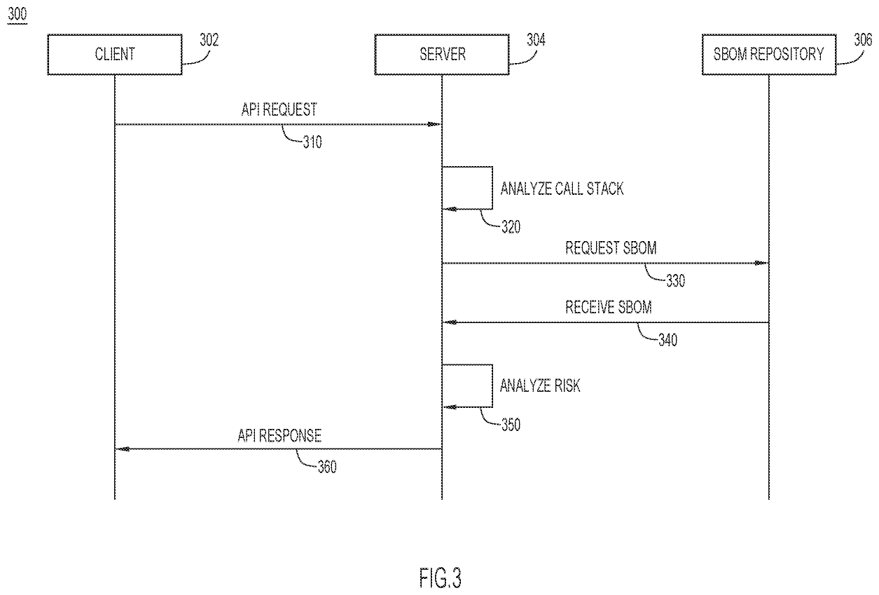

With reference now to FIG. 3, a flow diagram is provided depicting an API transaction 300 that is analyzed with respect to risk, according to an example embodiment. The API transaction 300 may involve a client 302, which is a client computing device that initiates the API transaction 300, and server 304, which corresponds to the other computing device participating in the API transaction 300. Also included is an SBOM repository 306, which can be a database that is either remote or local with respect to server 304. Client 302, server 304, and SBOM repository 306 may be implemented by computing device 120, risk analysis server 102, and database 118 (and/or database 136), respectively, which are depicted and described with reference to network environment 100 of FIG. 1.

At operation 310, client 302 provides an API request to server 304. The API request initiates API transaction 300, and can include instructions for server 304 to perform one or more network and/or computing tasks. Once the server 304 receives the API request, the server 304 analyzes the call stack at operation 320. The call stack can be scanned in order to identify which components of the call stack are active. As each component of a call stack can be mapped to a particular SBOM, the corresponding SBOMs for each active component can be identified by server 304.

The server 304 requests an SBOM from SBOM repository at operation 330. The requested SBOM may correspond to the components of the call stack that are determined to be involved in API transaction 300. In some embodiments, multiple components are involved in API transaction 300, so an SBOM can be requested for each component. The server 304 receives the requested SBOM at operation 340. The requested SBOM may include risk metadata that is descriptive of any known risks involved with the component to which the SBOM corresponds.

The server 304 analyzes the SBOM with respect to risk at operation 350. The server 304 can compare the risk metadata of the SBOM to a list of approved or denied components, sub-components, operations, remote calls, and the like. In some embodiments, the server 304 computes a risk score and assesses risk by comparing the risk score to a threshold value. If the risk is determined to be unacceptable, server 304 may terminate the API transaction 300, and can optionally transmit a notification to another party (e.g., a network administrator, client 302, etc.) indicating that the API transaction 300 was prevented due to unacceptable risk. Otherwise, if server 304 determines that there is no risk or that there is an acceptable amount of risk, then an API response can be calculated by server 304, which may involve performing one or more networking or computing operations depending on the nature of the API request. Once the API response is calculated, the server 304 provides the API response can to the client 302 at operation 360.

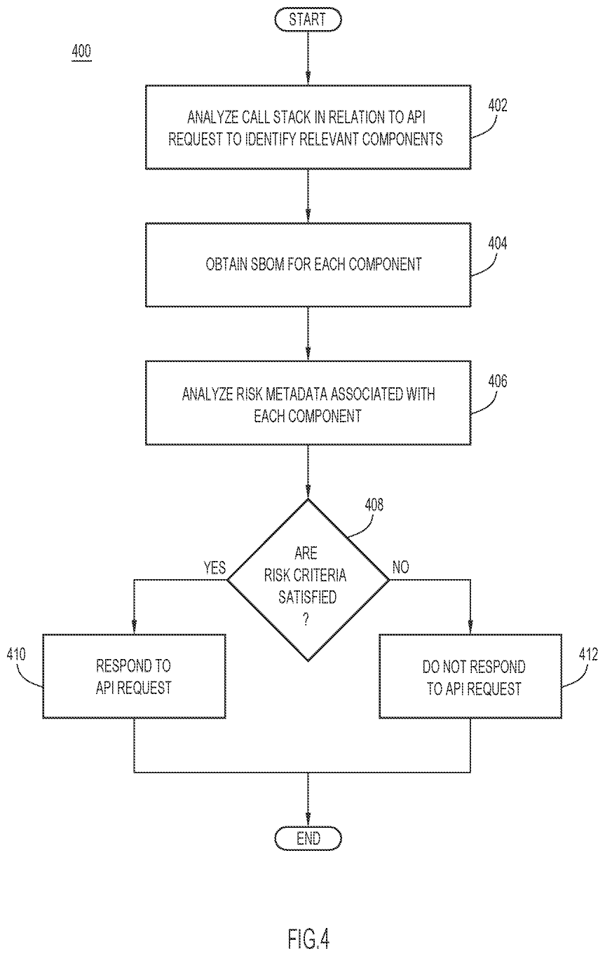

FIG. 4 is a flow chart of a method 400 for evaluating an API transaction for risk, according to an example embodiment.

A call stack is analyzed in relation to an API request to identify relevant components in the call stack at operation 402. When an API request is received by a server, a call stack associated with one or more software applications residing on the server can be scanned in order to identify any components in the call stack that are active and associated with the API transaction that is initiated by the API request. The components of the call stack can correspond to API software components and/or other components (e.g., a database querying module, a data processing module, etc.) that perform operations in relation to the API transaction.

An SBOM is obtained for each identified component at operation 404. Each component of the call stack can have a defined relationship to a particular SBOM that includes a description of that component's contents. Additionally, each SBOM can include risk metadata that describes any known or possible exposure to risk that is associated with the component described by the SBOM. The risk metadata can include any known vulnerabilities, conflicts with other applications, or any other issues that may impact an enterprise's exposure to risk. In some embodiments, the SBOM that is obtained may be an SBOM that is specific to a particular API.

The risk metadata that is associated with each component is analyzed at operation 406. A risk score can be calculated based on the risk metadata of any components involved in the API transaction. For example, rules can be provided for computing a risk score based on a number of vulnerabilities, type of vulnerabilities, severity of vulnerabilities, and the like. The various factors that serve as input to a risk score can be separately weighted so that some factors may have a greater or lesser influence over the resulting risk score as compared to other factors. In some embodiments, the risk metadata is compared to a known acceptable or unacceptable list of vulnerabilities or other forms of exposure to risk. In some embodiments, the risk metadata includes a risk score, which may be previously calculated or manually defined.

Operation 408 determines whether the risk criteria are satisfied. In embodiments in which a risk score is computed, the risk score may be compared to a threshold value in order to determine whether an API transaction involves an acceptable or unacceptable degree of risk. In embodiments in which the risk criteria comprise a list of acceptable or unacceptable vulnerabilities, actions performed in an API transaction, or components of an API transaction, the risk metadata can be compared to these risk criteria in order to determine whether the API transaction is authorized or unauthorized.

If the risk criteria are not satisfied, as determined by operation 408, then method 400 proceeds to operation 410 and the system responds to the API request. The response can include results of a processing request, a data fetching request, and/or any other desired operations that may be involved in an API transaction. In some embodiments, the response may be an acknowledgement that data has been received from the requesting entity that initiated the API transaction by providing the API request.

If the risk criteria are not satisfied, the method 400 proceeds to operation 412, and the system does not respond to the API request. The API transaction can be denied, and in some embodiments, a notification can be provided to the requesting entity that the API transaction is denied. The notification may optionally include a reason for denying the API request, such as an indication of a particular software module that failed to satisfy the risk criteria.

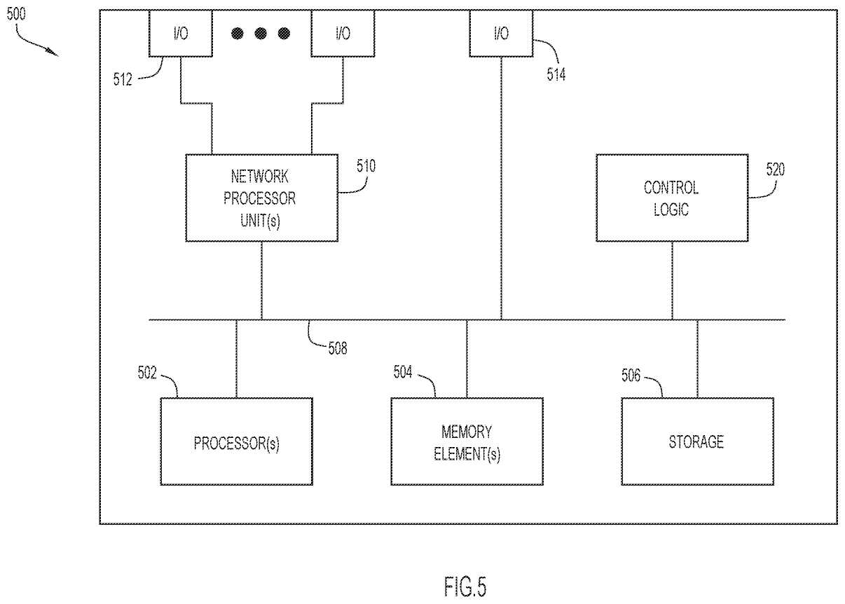

Referring now to FIG. 5, FIG. 5 illustrates a hardware block diagram of a computing device 500 that may perform functions associated with operations discussed herein in connection with the techniques depicted in FIGS. 1-4. In at least one embodiment, the computing device 500 may include one or more processor(s) 502, one or more memory element(s) 504, storage 506, a bus 508, one or more network processor unit(s) 510 interconnected with one or more network input/output (I/O) interface(s) 512, one or more I/O 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O 514 allow for input and output of data and/or information with other entities that may be connected to computing device 500. For example, I/O 514 may provide a connection to external devices such as a keyboard, keypad, mouse, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 602.11 (e.g., Wi-Fi®/Wi-Fi6®), IEEE 602.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a computer-implemented method including: analyzing a call stack in relation to an incoming application programming interface (API) request to identify one or more application components of the call stack that relate to the API request; obtaining a software bill of materials for each of the one or more application components; analyzing risk metadata associated with each software bill of materials to determine that the API request satisfies one or more risk criteria; and responding to the API request.

In some aspects, the techniques described herein relate to a computer-implemented method, wherein the risk metadata indicates a presence of a vulnerability.

In some aspects, the techniques described herein relate to a computer-implemented method, wherein the risk metadata includes a risk score for the one or more application components.

In some aspects, the techniques described herein relate to a computer-implemented method, wherein the one or more risk criteria are based on a trusted API source list, a trusted list of external calls made when responding to the API request, and a list of permitted operations with regard to responding to the API request.

In some aspects, the techniques described herein relate to a computer-implemented method, further including: presenting the call stack in a user interface in which each of the one or more application components of the call stack is labeled with respect to an identity of each application component.

In some aspects, the techniques described herein relate to a computer-implemented method, wherein each of the one or more application components of the call stack is further labeled with respect to risk.

In some aspects, the techniques described herein relate to a computer-implemented method, wherein the software bill of materials is specific to a particular API.

In some aspects, the techniques described herein relate to a computer-implemented method, further including: mapping additional application components of the call stack to an additional one or more software bills of material.

In some aspects, the techniques described herein relate to a computer-implemented method, further including: providing the risk metadata to a computing device from which the incoming API request is received.

In some aspects, the techniques described herein relate to a system including: one or more computer processors; one or more computer readable storage media; and program instructions stored on the one or more computer readable storage media for execution by at least one of the one or more computer processors, the program instructions including instructions to: analyze a call stack in relation to an incoming application programming interface (API) request to identify one or more application components of the call stack that relate to the API request; obtain a software bill of materials for each of the one or more application components; analyze risk metadata associated with each software bill of materials to determine that the API request satisfies one or more risk criteria; and respond to the API request.

In some aspects, the techniques described herein relate to a system, wherein the risk metadata indicates a presence of a vulnerability.

In some aspects, the techniques described herein relate to a system, wherein the risk metadata includes a risk score for the one or more application components.

In some aspects, the techniques described herein relate to a system, wherein the one or more risk criteria are based on a trusted API source list, a trusted list of external calls made when responding to the API request, and a list of permitted operations with regard to responding to the API request.

In some aspects, the techniques described herein relate to a system, wherein the program instructions further include instructions to: present the call stack in a user interface in which each of the one or more application components of the call stack is labeled with respect to an identity of each application component.

In some aspects, the techniques described herein relate to a system, wherein each of the one or more application components of the call stack is further labeled with respect to risk.

In some aspects, the techniques described herein relate to one or more non-transitory computer readable storage media having program instructions embodied therewith, the program instructions executable by a computer to cause the computer to perform operations including: analyzing a call stack in relation to an incoming application programming interface (API) request to identify one or more application components of the call stack that relate to the API request; obtaining a software bill of materials for each of the one or more application components; analyzing risk metadata associated with each software bill of materials to determine that the API request satisfies one or more risk criteria; and responding to the API request.

In some aspects, the techniques described herein relate to one or more non-transitory computer readable storage media, wherein the risk metadata indicates a presence of a vulnerability.

In some aspects, the techniques described herein relate to one or more non-transitory computer readable storage media, wherein the risk metadata includes a risk score for the one or more application components.

In some aspects, the techniques described herein relate to one or more non-transitory computer readable storage media, wherein the one or more risk criteria are based on a trusted API source list, a trusted list of external calls made when responding to the API request, and a list of permitted operations with regard to responding to the API request.

In some aspects, the techniques described herein relate to one or more non-transitory computer readable storage media, wherein the program instructions further cause the computer to: present the call stack in a user interface in which each of the one or more application components of the call stack is labeled with respect to an identity of each application component.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
analyzing a call stack in relation to an incoming application programming interface (API) request to identify one or more application components of the call stack that relate to the API request;
obtaining a software bill of materials for each of the one or more application components;
analyzing risk metadata associated with each software bill of materials to determine that the API request satisfies one or more risk criteria; and
responding to the API request.

2. The computer-implemented method of claim 1, wherein the risk metadata indicates a presence of a vulnerability.

3. The computer-implemented method of claim 1, wherein the risk metadata includes a risk score for the one or more application components.

4. The computer-implemented method of claim 1, wherein the one or more risk criteria are based on a trusted API source list, a trusted list of external calls made when responding to the API request, and a list of permitted operations with regard to responding to the API request.

5. The computer-implemented method of claim 1, further comprising:
presenting the call stack in a user interface in which each of the one or more application components of the call stack is labeled with respect to an identity of each application component.

6. The computer-implemented method of claim 5, wherein each of the one or more application components of the call stack is further labeled with respect to risk.

7. The computer-implemented method of claim 1, wherein the software bill of materials is specific to a particular API.

8. The computer-implemented method of claim 1, further comprising:
mapping additional application components of the call stack to an additional one or more software bills of material.

9. The computer-implemented method of claim 1, further comprising:
providing the risk metadata to a computing device from which the incoming API request is received.

10. A system comprising:
one or more computer processors;
one or more computer readable storage media; and
program instructions stored on the one or more computer readable storage media for execution by at least one of the one or more computer processors, the program instructions comprising instructions to:
analyze a call stack in relation to an incoming application programming interface (API) request to identify one or more application components of the call stack that relate to the API request;
obtain a software bill of materials for each of the one or more application components;
analyze risk metadata associated with each software bill of materials to determine that the API request satisfies one or more risk criteria; and
respond to the API request.

11. The system of claim 10, wherein the risk metadata indicates a presence of a vulnerability.

12. The system of claim 10, wherein the risk metadata includes a risk score for the one or more application components.

13. The system of claim 10, wherein the one or more risk criteria are based on a trusted API source list, a trusted list of external calls made when responding to the API request, and a list of permitted operations with regard to responding to the API request.

14. The system of claim 10, wherein the program instructions further comprise instructions to:
present the call stack in a user interface in which each of the one or more application components of the call stack is labeled with respect to an identity of each application component.

15. The system of claim 14, wherein each of the one or more application components of the call stack is further labeled with respect to risk.

16. One or more non-transitory computer readable storage media having program instructions embodied therewith, the program instructions executable by a computer to cause the computer to perform operations including:
analyzing a call stack in relation to an incoming application programming interface (API) request to identify one or more application components of the call stack that relate to the API request;
obtaining a software bill of materials for each of the one or more application components;
analyzing risk metadata associated with each software bill of materials to determine that the API request satisfies one or more risk criteria; and
responding to the API request.

17. The one or more non-transitory computer readable storage media of claim 16, wherein the risk metadata indicates a presence of a vulnerability.

18. The one or more non-transitory computer readable storage media of claim 16, wherein the risk metadata includes a risk score for the one or more application components.

19. The one or more non-transitory computer readable storage media of claim 16, wherein the one or more risk criteria are based on a trusted API source list, a trusted list of external calls made when responding to the API request, and a list of permitted operations with regard to responding to the API request.

20. The one or more non-transitory computer readable storage media of claim 16, wherein the program instructions further cause the computer to:
present the call stack in a user interface in which each of the one or more application components of the call stack is labeled with respect to an identity of each application component.
